(19) United States
(12) Patent Application Publication
(10) Pub. No.: US 2010/0182147 A1
(43) Pub. Date: Jul. 22, 2010

(54) REMOTE STORAGE OF DATA IN PHASE-CHANGE MEMORY

(75) Inventors: Stefan Rueping, Lengdorf (DE); Thomas Nirschl, Munich (DE); Ronald Kakoschke, Munich (DE); Franz Josef Bruecklmayr, Kaufering (DE); Markus Gail, Munich (DE); Berndt Gammel, Markt-Schwaben (DE); Gerd Dirscherl, Munich (DE)

Correspondence Address: DICKSTEIN SHAPIRO LLP, 1633 Broadway, NEW YORK, NY, 10019, US

(73) Assignee: INFINEON TECHNOLOGIES A.G., Neubiberg (DE)

(21) Appl. No.: 12/356,339

(22) Filed: Jan. 20, 2009

(51) Int. Cl. G08B 13/00

(52) U.S. Cl. 340/541

(57) ABSTRACT

A security circuit comprising including a sensor located remotely from a central alarm handler and configured to sense an attack, and a phase-change memory cell coupled to and located remotely with the sensor, and configured to store an alarm event when the attack is sensed.

### BACKGROUND

Phase-change memory (also known as PCM, PRAM, PCRAM, Chalcogenide RAM and C-RAM) is a type of non-volatile memory device that employs a reversible phase-change material to store information.

Phase-change memory uses a medium called chalcogenide, the physical state of which can be reversibly changed between crystalline and amorphous through the application of heat. The physical states have different electrical resistance properties that can be easily measured, making chalcogenide useful for data storage.

In the amorphous phase, the material is highly disordered, that is, there is an absence of regular order to the crystalline lattice. In this phase, the material demonstrates high resistivity and high reflectivity. In contrast, in the crystalline phase, the material has a regular crystalline structure and exhibits low reflectivity and low resistivity.

Phase-change memory uses electrical current to trigger the structural change. An electrical charge just a few nanoseconds in duration melts the chalcogenide in a given location; when the charge ends, the location's temperature drops so quickly that the disorganized atoms freeze in place before they can rearrange themselves back into their regular, crystalline order.

Going in the other direction, the process applies a longer, less-intense current that warms the amorphous patch without melting it. This energizes the atoms just enough that they rearrange themselves into a crystalline lattice, which is characterized by lower energy or electrical resistance.

To read recorded information, a probe measures the electrical resistance of the location. The amorphous state's high resistance is read as a binary 0; the lower-resistance, crystalline state is a 1.

FIG. 5 illustrates a phase-change memory cell 500 formed over a substrate 510. The substrate 510 includes a conductive line 520 coupled to a selection device 530. The selection device 530 may be, for example, a diode, transistor, or other similar device. The selection device 530 is electrically coupled to a lower electrode 540 formed in a pore 550. The pore 550 is defined as an aperture in an insulating layer 560. Sidewall spacers 570 are formed in the pore 550. A phase-change material 580 is formed in the pore 550 and over the insulator 560. An upper electrode or conductive line 590 is formed over the phase-change material 580. The phase-change material 580 may be set to a desired resistance by varying the magnitude of the applied current.

### BRIEF DESCRIPTION OF THE DRAWINGS

FIG. 1 illustrates a security circuit in accordance with an exemplary embodiment.

FIG. 2 illustrates a flowchart of a security method in accordance with another exemplary embodiment.

FIG. 3 illustrates a circuit in accordance with another exemplary embodiment.

FIG. 4 illustrates a flowchart of a method in accordance with another exemplary embodiment.

FIG. 5 illustrates a phase-change memory cell.

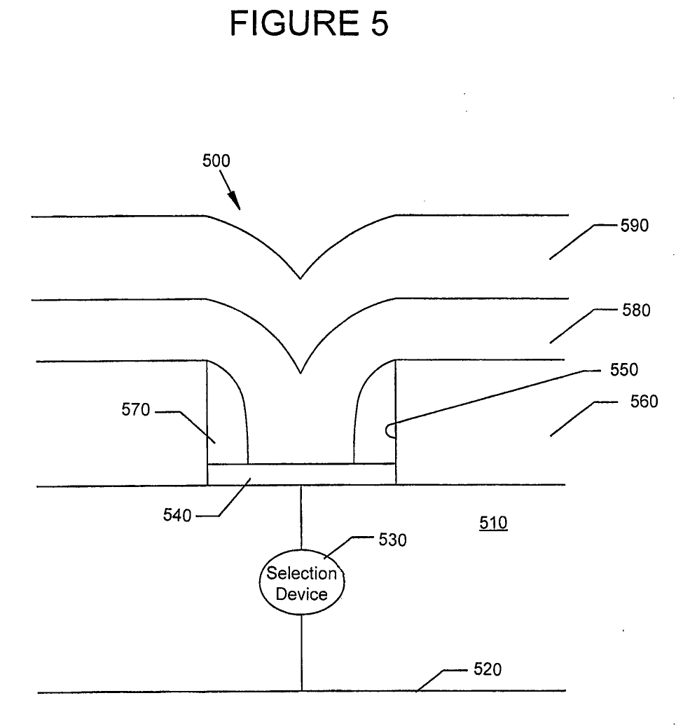

### DETAILED DESCRIPTION

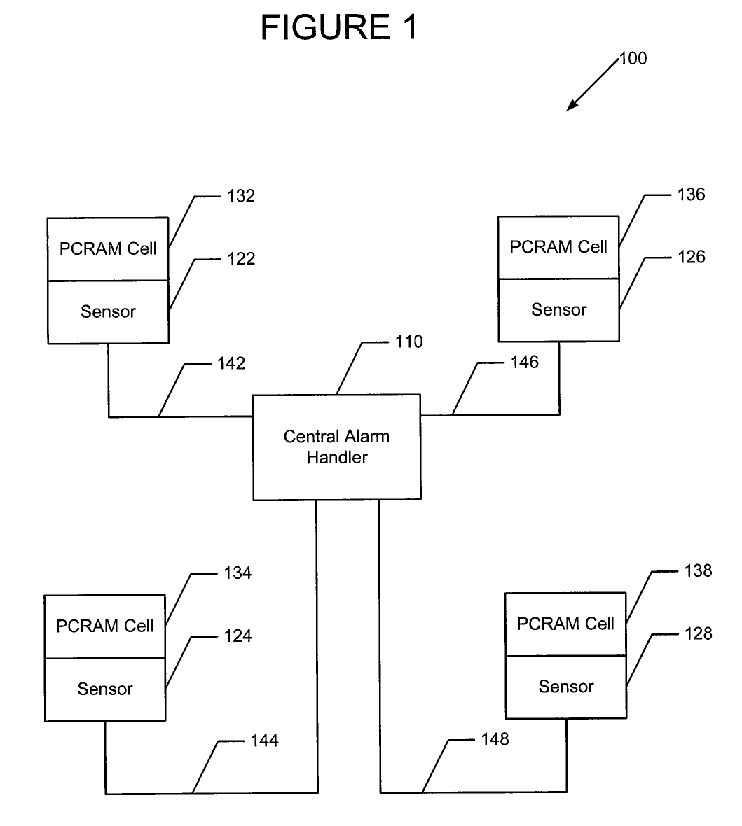

FIG. 1 illustrates a security circuit 100 in accordance with an exemplary embodiment. Security circuit 100 may be located in a chip, such as that of a contactless card, though the invention is not limited in this respect. Security circuit 100 may be used in any application having security requirements, such as electronic passport, identification cards, payment transactions, electronic banking, etc.

Security circuit 100 functions to protect security-relevant data stored on the chip against unauthorized access, and to prevent manipulation of the chip's method of operation. Unauthorized data access and/or operation manipulation has been accomplished using many different methods, as will be discussed below.

Security circuit 100 includes a central alarm handler 110, which may be, for example, a processor. A plurality of sensors 122, 124, 126, 128 are coupled to, but located remotely from, central alarm handler 110. More specifically, sensor 122 is coupled to central alarm handler 110 via conductive line 142, sensor 124 is coupled to central alarm handler 110 via conductive line 144, sensor 126 via conductive line 146, and sensor 128 via conductive line 148.

Each of sensors 122, 124, 126, 128 may be a light sensor configured to detect light attacks, a temperature sensor configured to detect temperature attacks, a voltage sensor configured to detect glitch attacks, or any other sensor suitable for detecting an attack used to access data stored on the chip or manipulate chip operation. When a sensor 122, 124, 126, 128 senses that its condition, that is light, temperature, voltage, etc., becomes out of range, such as exceeding a predetermined threshold, the sensor thereby senses an attack.

Light attacks may include, for example, irradiating the chip with X-rays to erase targeted memory areas and to reset codes, X-raying the chip in order to analyze its construction, optically reading ROM memory components, or exposing the chip to UV light in order to bring the micro-controller into an undefined state.

Temperature attacks may include, for example, heating a chip to randomly modify cells to exploit the fact that read and write temperature thresholds do not coincide in most non-volatile memories. By tuning a chip temperature to a value where write operations work but reads do not, or visa versa, a number of attacks can be mounted.

Glitch attacks may include, for example, changing the operating voltage or using voltage spikes to bring a microcontroller of the chip into an undefined state, over-clocking the chip, scanning signals present on corresponding chip circuits with the help of contact pins and subsequent analysis of those signals.

A plurality of phase-change memories 132, 134, 136, 138 are respectively coupled to and located remotely with sensors 122, 124, 126, 128. In one embodiment, phase-change memory cells 132, 134, 136, 138 are respectively coupled on top of sensors 122, 124, 126, 128.

When a sensor 122, 124, 126, 128 senses an attack, an alarm event is stored in the respective phase-change memory 132, 134, 136, 138. The alarm event is stored by applying an electrical current to the chalcogenide material of the phase-change memory 132, 134, 136, 138, thereby changing its resistance, as discussed above.

A phase-change memory cell 132, 134, 136, 138 can store the alarm event as a flag. In an alternative embodiment, phase-change memory 132, 134, 136, 138 stores the alarm event as an alarm count value indicating a number of times an attack is sensed by a respective sensor 122, 124, 126, 128. By storing an alarm count value rather than simply a flag, central alarm handler 110 may be designed to trigger an alarm action only when the alarm count value exceeds a predetermined alarm count value. The predetermined alarm count value may be stored in central alarm handler 110 or a separate memory device, and may be any value considered suitable. Of course this alarm count value could be zero, thereby triggering an alarm action each time an attack is sensed. However, there is a trade-off between security and performance; the more alarm actions are triggered, the more performance is sacrificed.

A phase-change memory cell 132, 134, 136, 138 may store an alarm event in either a digital or an analog manner. In a digital manner, there is one phase-change memory cell 132, 134, 136, 138 for each data bit, and each cell is turned on or off to represent a logical “1” or a logical “0”.

When storing the alarm event in an analog manner, only a single phase-change memory cell 132, 134, 136, 138 is required for a respective sensor 122, 124, 126, 128. The resistance of the chalcogenide material of the cell changes each time an electrical current is applied, or the resistance may be in proportion to the strength of the applied electrical current. As long as there is no clearing or erasing of the stored data, the resistance of the chalcogenide material generally will be further increased each time an electrical current is applied thereto. Since the resistance corresponds with the stored value, phase-change memory cells can act as an adder to increase the alarm count value. Since only a single cell is needed, analog storage is more area efficient than digital storage.

Phase-change memories 132, 134, 136, 138 are located remotely with sensors 122, 124, 126, 128, and thus alarm events are stored locally, as opposed to being stored centrally in central alarm handler 110. Central alarm handler 110 reads phase-change memories 132, 134, 136, 138 and may take any appropriate alarm action if necessary, such as a chip reset, disable, or shutdown. Central alarm handler 110 reads the local phase-change memories 132, 134, 136, 138 at startup in order to determine if a local attack occurred anywhere in the chip. In an alternative embodiment, central alarm handler 110 reads the local phase-change memories 132, 134, 136, 138 periodically, or at any time deemed appropriate. Further, central alarm handler 110 can read any one, or more of the local phase-change memories 132, 134, 136, 138 at any time.

While FIG. 1 shows security circuit 100 having four sensors and four respective phase-change memories, the invention is not limited in this respect. Security circuit 100 may have any number of sensors and any number of phase-change memory cells suitable for the intended purpose, provided that at least one a phase-change memory cell is coupled to and located remotely with a sensor.

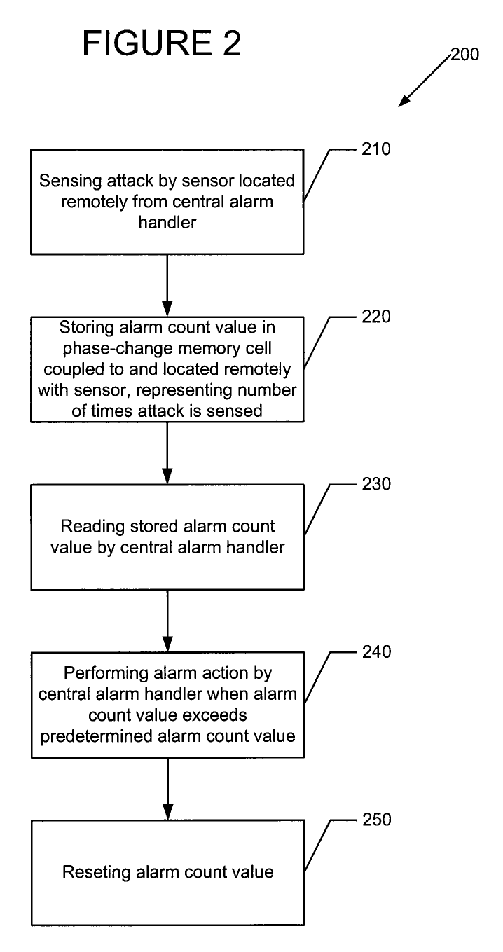

FIG. 2 illustrates a flowchart 200 of a security method in accordance with another exemplary embodiment.

Under the security method, first an attack is sensed by one or more sensors 122, 124, 126, 128, located remotely from central alarm handler 110. (Step 210.) Using a light sensor as an example, a light attack may be sensed when the sensor senses that a light intensity is out of an expected range, such as when the light intensity exceeds a predetermined light intensity threshold, thereby indicating an attack.

When an attack is sensed by a sensor 122, 124, 126, 128, an alarm event is stored in a phase-change memory cell 132, 134, 136, 138 coupled to and located remotely with the respective sensor 122, 124, 126, 128, such as by increasing a stored alarm count value. (Step 220.) The alarm count value therefore represents the number of times an attack is sensed by the particular sensor 122, 124, 126, 128. Again, the phase-change memory cell 132, 134, 136, 138 may store the alarm count value in analog or digital format.

Central alarm handler 110 reads the stored alarm count values in the phase-change memory cell 132, 134, 136, 138. (Step 230.) Central alarm handler 110 can read phase-change memory cell 132, 134, 136, 138 at startup to determine whether there has been a local attack on the chip. Alternatively, central alarm handler can read the stored alarm count value in phase-change memory cell 132, 134, 136, 138 periodically or any time deemed appropriate. When the alarm count value exceeds a predetermined alarm count value, central alarm handler 110 performs an alarm action. (Step 240.) The alarm action can be a chip shut down, a clearing of all security data, a security check, or any other responsive action considered appropriate.

At some point, such as after the alarm action is performed, the stored alarm count value is reset, so that circuit 100 is not continuously in an alarm condition. As discussed above, the count value may be reset by applying a longer, less-intense current that warms the chalcogenide material of the cell without melting it. This energizes the atoms just enough that they rearrange themselves into a crystalline lattice, which is characterized by lower energy or electrical resistance. The cell is then read as a binary 0.

There are many advantages to including local phase-change memory cells 132, 134, 136, 138 at sensors 122, 124, 126, 128 to store alarm events. For example, the alarm event is stored in a non-volatile manner and is therefore present even if an attacker switches off the power to security circuit 100 when the sensor triggers an alarm.

Also, the alarm event information is available locally and does not rely on central alarm handler 110. Thus if an attacker disables central alarm handler 110, an alarm response, such as a security reset, can still occur.

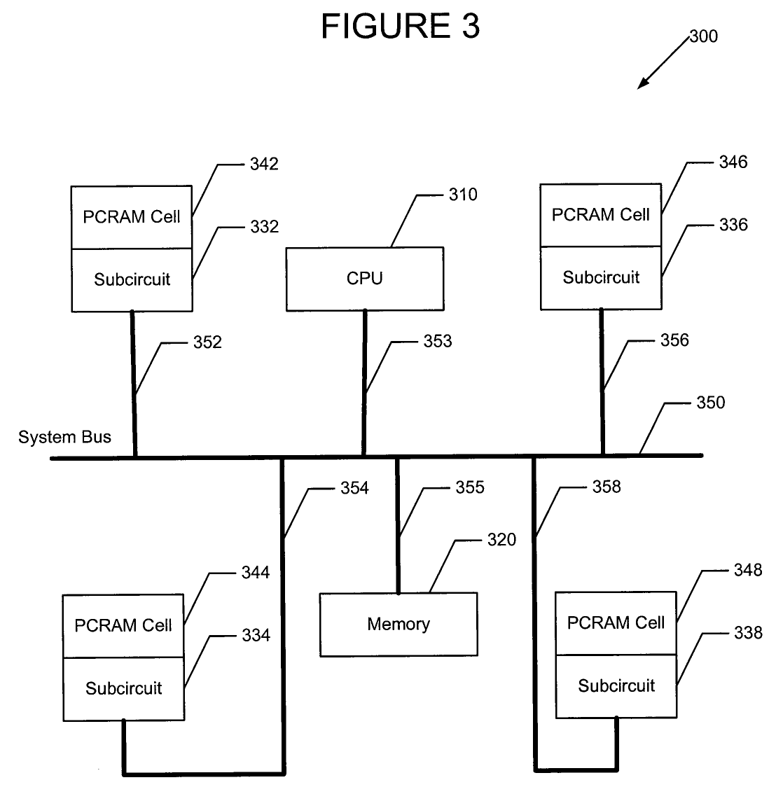

FIG. 3 illustrates a circuit 300 in accordance with another exemplary embodiment. Circuit 300 may be located in a chip, such as that of a contactless card, though the invention is not limited in this respect.

Circuit 300 includes central processing unit (CPU) 310, memory 320, subcircuits 332, 334, 336, 338, each coupled to system bus 350, and phase-change memory cells 342, 344, 346, 348. More specifically, CPU 310 is coupled to system bus 350 via conductive line 353, memory 320 is coupled to system bus 350 via conductive line 355, and subcircuits 332, 334, 336, 338 are coupled to system bus via conductive lines 352, 354, 356, 358, respectively.

Phase-change memory cells 342, 344, 346, 348 are respectively coupled to and located remotely with subcircuits 332, 334, 336, 338. In one embodiment, phase-change memory cells 342, 344, 346, 348 are respectively located on top of subcircuits 332, 334, 336, 338.

Phase-change memory cells 342, 344, 346, 348 are configured to store configuration data that would otherwise be hosted in special function registers (SFR). This configuration data is therefore available locally to subcircuits 332, 334, 336, 338, and CPU 310 does not need to transfer the configuration data from memory 320 to SFRs during startup.

Phase-change memory cells 342, 344, 346, 348 may store configuration data in a digital manner. More specifically, one phase-change memory cell 342, 344, 346, 348 corresponds to a single data bit, and each cell is turned on or off to represent a logical “1” or a logical “0”. If there are 16 bits of configuration data, there are 16 phase-change memory cells 342, 344, 346, 348, with electrical currents causing the respective cells to store either a logical “1” or a logical “0”.

Alternatively, phase-change memory cells 342, 344, 346, 348 may store configuration data in an analog manner. As discussed above, only a single cell is needed, with the resistance of the cell changing each time an electrical current is applied or generally in proportion to the strength of the electrical current.

Also, the configuration data from each of phase-change memory cells 342, 344, 346, 348 may be loaded into the respective subcircuits 332, 334, 336, 338 in parallel. Conventionally, values are read in a serial manner, that is, at startup a CPU reads a first value and writes it into a first special function register, then subsequently reads a second value and writes it into a second special function register, etc. Now, with the local, non-volatile storage of configuration data in phase-change memory cells 342, 344, 346, 348, the configuration data in each of phase-change memory cells 342, 344, 346, 348 can be loaded into respective subcircuits 332, 334, 336, 338 in parallel (i.e., concurrently) without using CPU 310 that couples memory 320 with subcircuits 332, 334, 336, 338. Startup time is effectively reduced. Additionally, a transfer of the configuration data through the circuit 300 is avoided, thereby reducing an opportunity for an attacker to listen to or manipulate the configuration data during such transfer.

Further, with the local, non-volatile storage of configuration data in phase-change memory cells 342, 344, 346, 348, centralized storage of the configuration data for the circuit is not needed, and the configuration data is present at subcircuits 332, 334, 336, 338 even after a power down.

Subcircuit 332, 344, 346, 348 may be any type of logic requiring configuration data during startup or any other time. In one embodiment, subcircuit 332, 344, 346, 348 is a random number generator. In such a case, the corresponding phase-change memory cell 342, 344, 346, 348 is configured to store a seed for the random number generator locally such that it is available immediately during start-up. Further, any time there is a power up the seed can be changed. At the next power up there is a new seed, even if there were several system power-downs in between.

In another embodiment, subcircuit 332, 344, 346, 348 is an analog subcircuit. In such a case, the corresponding phase-change memory cell 342, 344, 346, 348 is configured to store adjustment values locally in a non-volatile manner. This enables stable operation without any system interaction, such as loading a SFR value from memory 320.

In another embodiment, subcircuit 332, 344, 346, 348 is a communication subcircuit. In such a case, the corresponding phase-change memory cell 342, 344, 346, 348 is configured to act as a buffer. Since the phase-change memory cell 342, 344, 346, 348 is placed on top of the communication subcircuit, the subcircuit area is minimized.

Alternatively, in another embodiment, subcircuit 332, 344, 346, 348 is an encryption unit. In such a case, the corresponding phase-change memory cell 342, 344, 346, 348 is configured to store keys locally. There is therefore no need to transfer the key through circuit 300 during start-up.

While FIG. 3 shows circuit 300 having four subcircuits and four respective phase-change memories, the invention is not limited in this respect. Circuit 300 many have any number of subcircuits and any number of phase-change memory cells suitable for the intended purpose, provided that at least one phase-change memory cell is coupled to and located remotely with a subcircuit.

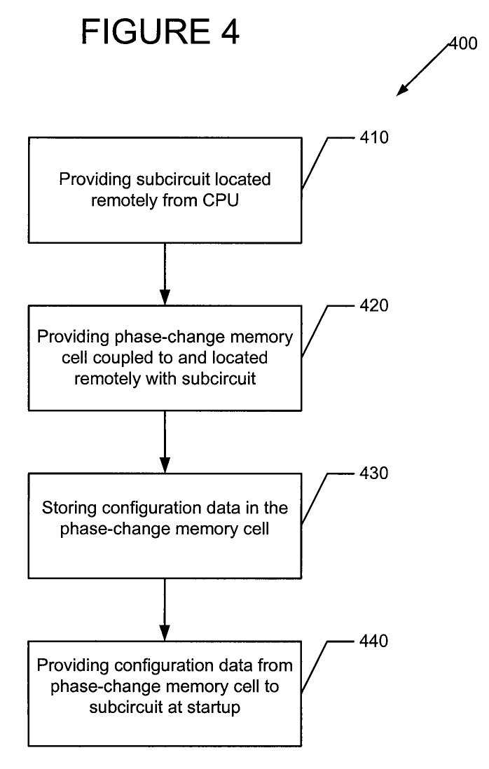

FIG. 4 illustrates a flowchart 400 of a method in accordance with another exemplary embodiment.

A subcircuit 332, 334, 336, 338 is provided remotely from CPU 310. (Step 410.) A phase-change memory cell 342, 344, 346, 348 is provided to be coupled to and located remotely with subcircuit 332, 334, 336, 338. (Step 420.) Configuration data is stored in phase-change memory cell 342, 344, 346, 348. (Step 430.) As discussed above, the configuration data can be stored in either analog or digital format. At startup, the configuration data is provided from phase-change memory cell 342, 344, 346, 348 to subcircuit 332, 334, 336, 338. (Step 440.)

Although specific embodiments have been illustrated and described herein, it will be appreciated by those of ordinary skill in the art that a variety of alternate and/or equivalent implementations may be substituted for the specific embodiments shown and described without departing from the scope of the present application. This application is intended to cover any adaptations or variations of the specific embodiments discussed herein.

What is claimed is:

1. A security circuit comprising:
a sensor located remotely from a central alarm handler and configured to sense an attack; and
a phase-change memory cell coupled to and located remotely with the sensor, and configured to store an alarm event when the attack is sensed.

2. The security circuit of claim 1, further comprising:
a plurality of sensors each located remotely from the central alarm handler and each configured to sense an attack; and
a plurality of phase-change memory cells respectively coupled to and located remotely with the sensors, and respectively configured to store an alarm event when the attack is sensed.

3. The security circuit of claim 1, wherein the phase-change memory cell is configured to store the alarm event in a non-volatile manner.

4. The security circuit of claim 1, wherein the phase-change memory cell is further configured to store an alarm count value representing a number of times an attack is sensed.

5. The security circuit of claim 4, wherein the central alarm handler is configured to read the stored alarm count value, and to compare the stored alarm count value with a predetermined alarm count value.

6. The security circuit of claim 5, wherein the central alarm handler is further configured to perform an alarm action when the alarm count value exceeds the predetermined alarm count value.

7. The security circuit of claim 6, wherein the alarm action is a system shut down.

8. The security circuit of claim 4, wherein the phase-change memory cell is configured to store the alarm count value in analog format.

9. The security circuit of claim 1, wherein the sensor is configured to sense at least one of light, temperature and a glitch condition as the attack event.

10. The security circuit of claim 2, wherein each of the plurality of sensors is configured to sense when a respective condition is outside a respective predetermined threshold range to indicate an attack.

11. A circuit comprising:
a subcircuit located remotely from a central alarm handler and requiring configuration data; and
a phase-change memory cell coupled to and located remotely with the subcircuit, and configured to store the configuration data,
wherein the phase-change memory cell provides the configuration data to the subcircuit.

12. The circuit of claim 11, wherein the configuration data is stored in digital format.

13. The circuit of claim 11, wherein the configuration data is stored in analog format.

14. The circuit of claim 11, further comprising:
a plurality of subcircuits each requiring configuration data during startup of the circuit; and
a plurality of phase-change memory cells respectively coupled to and located remotely with the subcircuits, and each configured to store the respective configuration data,
wherein the plurality of phase-change memory cells respectively provide the configuration data to the plurality of subcircuits.

15. A method of providing security for a circuit, the method comprising:
sensing an attack by a sensor located remotely from a central alarm handler; and
storing an alarm event in a phase-change memory cell coupled to and located remotely with the sensor, when the attack is sensed.

16. The method of claim 15, further comprising storing the alarm event in a non-volatile manner.

17. The method of claim 15, wherein the storing comprises storing an alarm count value representing a number of times an attack is sensed.

18. The method of claim 17, further comprising:
reading the stored alarm count value by the central alarm handler; and
comparing the stored alarm count value with a predetermined alarm count value, by the central alarm handler.

19. The method of claim 18, further comprising performing an alarm action by the central alarm handler when the alarm count value exceeds the predetermined alarm count value.

20. The method of claim 19, wherein the alarm action is a system shut down.

21. The method of claim 19, further comprising resetting the stored alarm count value after the alarm action is performed.

22. The method of claim 18, wherein the sensing the attack comprises sensing at least one of a light, temperature and glitch condition.

23. A method performed in a circuit having a subcircuit located remotely from a central alarm handler and a phase-change memory cell coupled to and located remotely with the subcircuit, the method comprising:
storing configuration data in the phase-change memory cell; and
providing the configuration data from the phase-change memory cell to the subcircuit at startup of the circuit.

24. The method of claim 23, wherein the configuration data is stored in digital format.

25. The method of claim 23, wherein the configuration data is stored in analog format.
